(19) United States
(12) Patent Application Publication
(10) Pub. No.: US 2019/0011023 A1
(43) Pub. Date: Jan. 10, 2019

(54) CONE SHAPED VARIABLE GEAR CYLINDER APPARATUS

(71) Applicant: Susan Dietrich, Lackawanna, NY (US)

(72) Inventor: Susan Dietrich, Lackawanna, NY (US)

(21) Appl. No.: 15/645,613

(22) Filed: Jul. 10, 2017

(51) Int. Cl. F16H 15/24; F16H 61/664; F16H 61/30

(52) U.S. Cl. CPC F16H 15/24; F16H 41/04; F16H 61/30; F16H 61/664

(57) ABSTRACT

A cone shaped transmission apparatus automatically changes gear ratios for the rear drive wheels. The conical shape of the transmission apparatus enables a pair of wing arms to hingedly articulate, so as to change spacing and position relative to each other. This changing articulation of the wing arms displaces a wing collar that works to drive a plurality of shaft gears along a central shaft into selective mesh engagement with drive gears in the vehicle. Gear ratios between about, 1:1 to 3:1 are achieved. A tapered cylinder forces the hingedly articulating wings to change spacing and position relative to each other to axially displace at least one shaft gear into meshed engagement and disengagement with a plurality of drive gears. The transmission connects to an engine, flywheel, and torque converter to transfer power to the drive wheels. A hydraulic and electrical system enables operation of the transmission apparatus.

### FIELD OF THE INVENTION

The present invention relates generally to a cone-shaped variable gear cylinder apparatus. More so, the present invention relates to a cone-shaped variable gear cylinder operational within the transmission to automatically change gear ratios of rear-wheel drive vehicles. Generally, the cone-shaped variable gear cylinder rotates independently within the transmission powered by the vehicle engine via the torque converter. The cone-shaped cylinder is open at its small end and closed at the large end. Generally the small end accommodates a shaft through the interior of the cylinder a collar slides on the shaft on either side of the collar are attached hinged wing arms. Generally as the collar travels to the larger diameter of the cone-shaped cylinder the wing arms expand, sliding in a groove on the inside wall of the cone-shaped cylinder. Generally as the wing arms expand inside the cylinder the orbital diameter increases, changing the ratio between the cylinder and the shaft.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, the power generated by the engine flows to a transmission before it reaches the drive wheels. The basic function of the transmission is to control the speed and torque available to the drive wheels for different driving conditions. For example for climbing a hill, more torque is required. This is possible by reducing the speed of the transmission a higher torque can be achieved for the same power input.

It is known in the art that manual transmissions work on the simple principle of gear ratio. An input shaft and an output shaft are operatively connected through a counter shaft. By sliding the gears, different transmission ratios are possible. Often, the gear teeth have a synchronizer cone teeth arrangement. A hub is fixed to the shaft. A sleeve that is used to slide over the hub is also used in this gear arrangement. If the hub is displaced to connect with the teeth of the synchronizer cone, the gear and shaft will turn together or the desired locking action will be achieved. But during the gear box operation the shaft and gear will be rotating at different speeds.

A synchronizer ring helps to match the speed of the gear with the speed of the shaft. The synchronizer ring is free to rotate with the hub, but is free to slide axially. Before moving the sleeve, a clutch pedal is pressed. This way, our flow to the gear is discontinued. When the sleeve is moved, the sleeve moves the synchronizer ring against the cone. Due to the high frictional force between the synchronizer ring and the cone, the speed of the gear will become the same as the shaft. At this time, the sleeve can be slid in further and it will become locked with the gear. Thus, the gear gets locked with the shaft in an efficient and smooth way. The same mechanism is used to shift between different gears.

It is also known that automatic transmissions work on a planetary gear set. A planetary gear set has a central large gear surrounded by meshing smaller gears, arrange in a planetary configuration. A planetary carrier houses the gears. A ring gear encapsulates the planetary gear. Planetary gear sets have two inputs and one output. In automatic transmission, the output rotation is drawn from the planetary carrier. The two inputs are connected to the ring gear and some gear. The ring gear is stationary and rotation is given exclusively to the sun gear. This will cause the carrier to spin. The ring gears also rotating. The ring and some gears rotate at the same speed. Thus, the whole mechanism moves as a single unit. Thus, the operation of automatic transmissions is about transferring different rotational speeds into the ring and some gears. This speed variation can be transmitted by engaging a few clutch packs.

Typically, most rear wheel drive transmissions are constructed with a short input shaft which transmits driving torque from a source such as an engine through a pair of gears known as a headset, to a countershaft. The countershaft is located parallel to the input shaft and is positioned amid a plurality of driving gears. An output shaft, having a plurality of driven output gears surrounding the shaft, is located parallel to the countershaft. Each of the driven output gears surrounding the output shaft is in mesh with a corresponding driving gear from the plurality of gears on the countershaft.

Usually, the output shaft is coaxial with the input shaft. A number of axially reciprocating synchronizers are coupled to the output shaft or countershaft to engage one of the speed gears on one side and another of the speed gears on its other side. One of the speed gears on the output shaft is a reverse gear which is in mesh with the driving gear on the countershaft through an idler gear. Most often, the output shaft is coaxial with the input shaft with one of the synchronizers arranged to engage, in one position, the input shaft directly to the output shaft to effect one of the speed changes.

Other proposals have involved rear wheel drive transmissions. The problem with these transmissions is that they do not provide a smooth gear ratio change, and they are not adaptable to operate with different rear wheel drive vehicles. Also, the mesh between gears can be noisy and generate excess heat. Even though the above transmissions meet some of the needs of the market, a cone shaped transmission apparatus automatically changes gear ratios for the rear drive wheels; whereby the conical shape of the transmission apparatus enables a pair of wing arms to hingedly articulate, so as to change spacing and position relative to each other; whereby the changing articulation of the wing arms displaces a wing collar that works to drive a plurality of shaft gears along a central shaft into selective mesh engagement with drive gears in the vehicle is still desired.

### SUMMARY

Illustrative embodiments of the disclosure are generally directed to a cone shaped variable gear cylinder. The cone-shaped variable gear cylinder is operational to automatically change gear ratios to the rear drive wheels of a vehicle. The generally conical shape of the cylinder apparatus enables a pair of wing arms to hingedly articulate from a small to a larger diameter relative to each other. This changing articulation of the wing arms displaces a wing collar that works to drive a Shaft and gears. In this manner, the changing articulation varies the shafts rotational speed and thus its ratio.

In some embodiments, the cone shaped variable gear cylinder comprises a tapered cylinder having a generally cone shape that forces a pair of hingedly articulating wings to change spacing and position relative to each other based on their position in the tapered cylinder, so as to axially displace at least one shaft gear into meshed engagement and disengagement with a plurality of drive gears. The tapered cylinder is defined by a sidewall, a wide end, and a narrow end, with the narrow end open. A pair of rails runs along the length of the sidewall. A central shaft extends concentrically through the length of the tapered housing. The central shaft is defined by a wing end and a gear end.

A wing collar slides along the wing end of the central shaft. At least one shaft gear operatively connects to the wing collar. The at least one shaft gear slides along the gear end of the central shaft in correlation to the wing collar. Thus, the wing collar axially displaces the at least one shaft gear into selective mesh engagement with a plurality of drive gears. A pair of wing arms defined by an inner end and an outer end drives the wing collar along the central shaft. The inner end of the wing arms hingedly join with the wing collar, and the outer end of the wing arms move along the rails on the sidewall of the housing. A wing arm wheel joins the outer end of the wing arms to roll along the rails. Because the wing arm wheel and rails are in constant contact, there is no gear change but instead a seamless, undetectable increase, decrease in the ratio and central shaft.

An engine displaces power to a flywheel and torque converter. The torque converter operatively connects to the cone-shaped variable cylindrical gear. The position of the wing arms conform to changing diameters of the gear cylinder. For example, when the wing arms are displaced towards the wide end of the gear cylinder, the wing collars are generally extended and the wing collar is carried to the wide end. However, when the wing arms are displaced towards the narrow end of the gear cylinder, the wing arms hingedly fold inwardly and the wing collar is carried to the narrow end of the gear cylinder. The wing collar axially displaces a plurality of shaft gears at the gear end of the central shaft into selective mesh engagement with a plurality of drive gears, so as to achieve gear ratios from 1:1 to 3:1. Thus, the shaft gears are axially displaced in communication with correlating drive gears based on the position of the wing arms.

In one aspect, a cone shaped variable gear apparatus comprises:

a cylindrical gear defined by a sidewall, a wide end, and a narrow end, whereby the wide end is closed and the narrow end forms a narrow opening;
a pair of rails running along the length of the sidewall between the wide end and the narrow end;
a central shaft extending concentrically through the length of the tapered housing, the central shaft defined by a wing end and a gear end;
a wing collar operatively joined with the central shaft, the wing collar sliding along the wing end of the central shaft;
at least one shaft gear joined with the central shaft, the at least one shaft gear operatively connected to the wing collar, whereby the wing collar displaces the at least one shaft gear along the gear end of the central shaft, whereby the at least one shaft gear selectively engages and disengages a plurality of drive gears;
a pair of wing arms defined by an inner end and an outer end, the inner end of the pair of wing arms hingedly joined with the wing collar, the outer end of the pair of wing arms operatively joined with the pair of rails to move along the pair of rails, the pair of wing arms displacing the wing collar along the central shaft, whereby the disposition of the pair of wing arms conforms to the diameter of the tapered cylinder; and
a pair of tension springs generating tension for pressing the outer end of the pair of wing arms against the pair of rails.

In another aspect, the apparatus further comprises an engine operable to generate power, the engine connected to a flywheel, the flywheel connected to a torque converter, the torque converter operable to transfer the power to the cone-shaped variable gear cylinder.

In another aspect, the apparatus further comprises a bolt and a bolt hole for fastening the flywheel and a transmission cover.

In another aspect, the apparatus further comprises a plurality of impeller fins operatively connected to the flywheel.

In another aspect, the apparatus further comprises a retainer bolt operable to fasten the pair of tension springs to the tapered housing.

In another aspect, the apparatus further comprises a shaft brake.

In another aspect, the apparatus further comprises a hydraulic oil pump for containing a hydraulic fluid.

In another aspect, the apparatus further comprises a seal to inhibit leakage of the hydraulic fluid.

In another aspect, the apparatus further comprises a hydraulic ram and a plunger operable to displace the hydraulic fluid.

In another aspect, the apparatus further comprises a hydraulic ram controller and a hydraulic ram return spring.

In another aspect, the apparatus further comprises a check ball.

In another aspect, the apparatus further comprises an electronic control module, a wiring harness, a wiring, and a plurality of solenoids.

In another aspect, the apparatus further comprises a wing arm wheel joined with the outer end of the pair of wing arms.

In another aspect, the central shaft comprises a shaft rail.

In another aspect, the central shaft comprises at least one square key notch operable to engage the shaft rail.

In another aspect, the at least one square key notch is disposed at the wing end and the gear end of the central shaft.

In another aspect, the at least one square key notch helps inhibit the wing collar from rotating around the shaft rail while sliding along the length of the central shaft.

In another aspect, the central shaft is defined by an oil channel disposed concentrically along the length of the central shaft.

In another aspect, the apparatus further comprises an oil pump, an oil pick up tube, an oil drain plug, and oil restricted wiring.

In another aspect, the apparatus further comprises a bearing and race assembly.

In another aspect, the apparatus further comprises a flat sleeve bearing, a bearing cap, a needle bearing, and a bearing collar.

In another aspect, the apparatus further comprises an actuator.

In another aspect, the apparatus further comprises a constant power source and a vehicle main computer.

One objective of the transmission apparatus is to change the gear ratio with minimal mechanical manipulations, so as to create a seamless, undetectable increase, decrease in the ratio and central shaft.

Another objective of the transmission apparatus is to maintain a smooth rolling relationship between the wing arms and the sidewall of the tapered housing.

Another objective of the transmission apparatus is to articulate the wing arms in relation to the diameter of the cylindrical gear.

Another objective of the transmission apparatus is to provide a rear wheel transmission that can be operable with any vehicle.

Another objective of the transmission apparatus is to provide a transmission apparatus that has an output shaft that does not slide, but rather enables a wing collar and at least one shaft gear to slide.

Another objective of the transmission apparatus is to provide transmission apparatus that creates a gear ratio between about, 1:1 to 3:1.

Another objective of the transmission apparatus is to provide an automatic transmission operable with rear drive wheels, whereby the change between the rear-wheel drive can be performed according to various driving conditions of the automotive vehicle and further the clutch may be automatically operated by pressure oil used in the automatic transmission in accordance with the driving condition of the vehicle.

Another objective of the transmission apparatus is to provide an automatic transmission that is inexpensive to manufacture.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary cone shaped variable gear apparatus operatively connected to an engine, a flywheel, and a torque converter, in accordance with an embodiment of the present invention;

FIGS. 2A and 2B illustrate a sectioned view of a cone shaped transmission apparatus, where FIG. 2A is a top half of the apparatus, and FIG. 2B is a bottom half of the apparatus, in accordance with an embodiment of the present invention; and

FIGS. 3A, 3B, and 3C illustrate the cone shaped variable gear cylinder shown in FIGS. 2A and 2B, where FIG. 3A shows the pair of winged arms extended coaxially at the wide end of the tapered cylinder, FIG. 3B shows the pair of winged arms moving towards the narrow end of the tapered cylinder, and FIG. 3C shows the pair of winged arms folded at the narrow end of the tapered cylinder.

Like reference numerals refer to like parts throughout the various views of the drawings.

### DETAILED DESCRIPTION OF THE INVENTION

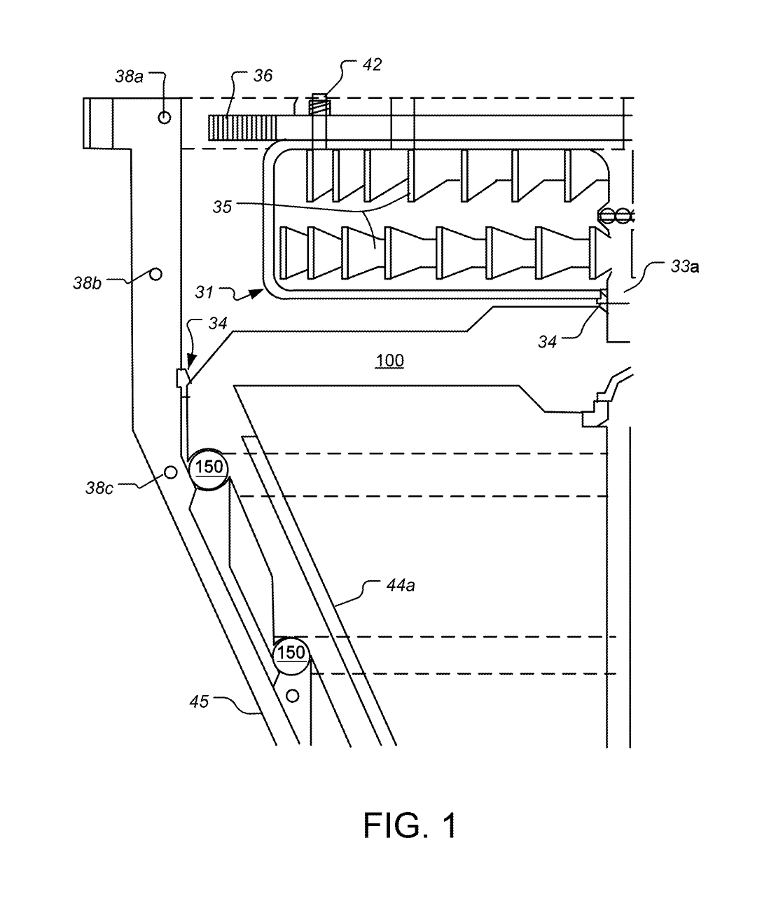

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

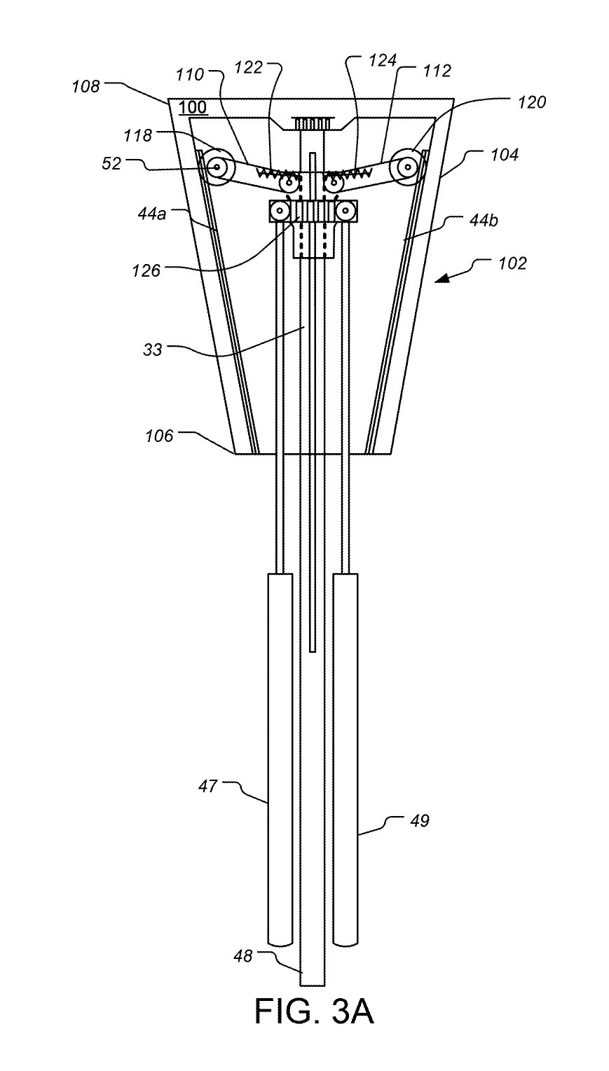

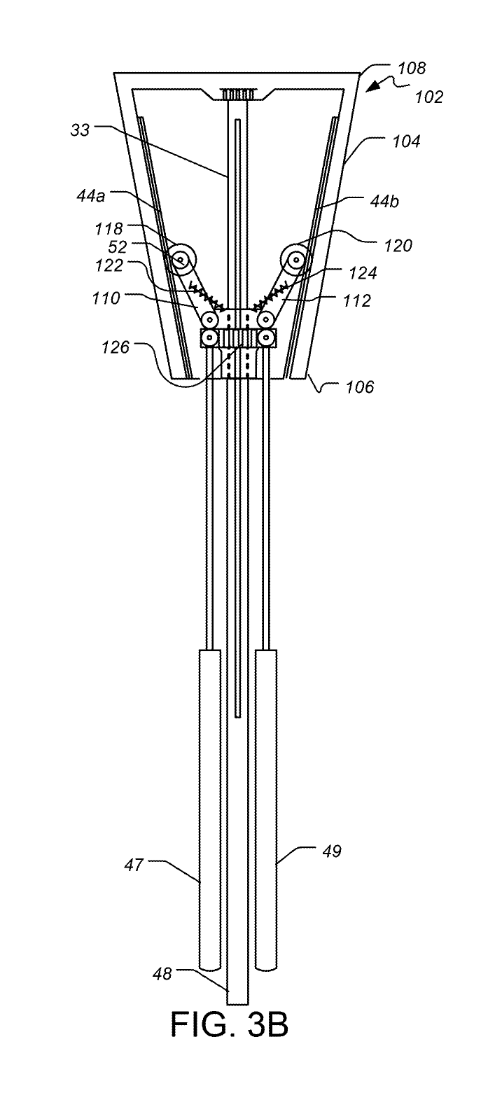

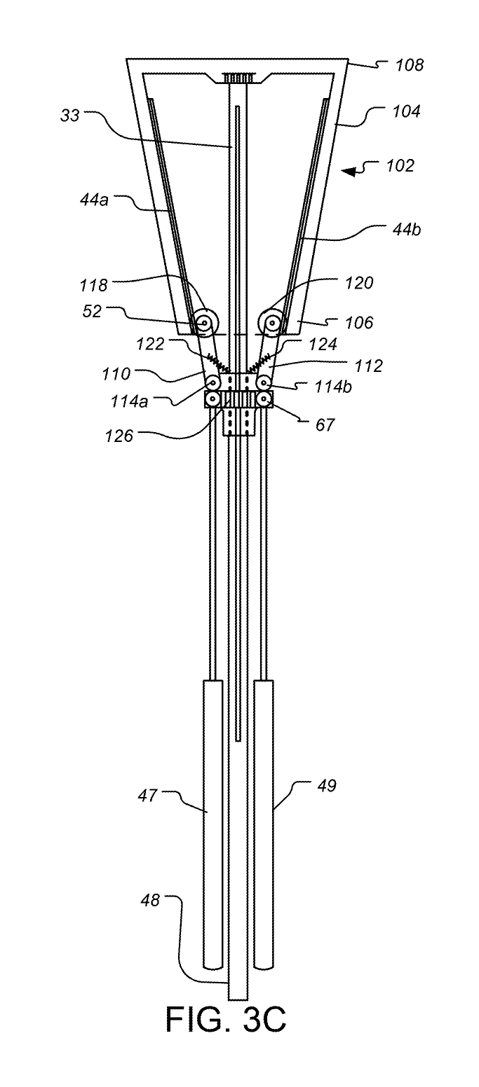

A cone shaped variable gear apparatus 100 is referenced in FIGS. 3A, 3B, 3C. The cone shaped variable gear cylinder apparatus 100; hereafter “apparatus 100” serves to automatically change gear ratios for the rear drive wheels of a vehicle. Apparatus 100 allows an internal combustion engine, best suited to run at a relatively high rotational speed, to provide a range of speed and torque outputs necessary for vehicular travel. In one embodiment, apparatus 100 is operatively connected to a constant power source and a vehicle main computer.

The generally conical shape of the transmission apparatus 100 enables a pair of wing arms 110, 112 to hingedly articulate about a pivot point 52, so as to change spacing and position relative to each other. This changing articulation of the wing arms 110, 112 displaces a wing collar 126 that works to drive a plurality of shaft gears 47, 48, 49 along a central shaft 33 into selective mesh engagement with a plurality of drive gears 50, 57 for the vehicle. In this manner, gear ratios between about, 1:1 to 3:1 may be achieved for a rear wheel drive vehicle.

As FIG. 1 references, apparatus 100 comprises a tapered housing 102 having a generally conical shape. The tapered housing 102 is defined by a sidewall 104, a wide end 108, and a narrow end 106, with the narrow end forming an opening. A pair of rails 44a, 44b runs along the length of the sidewall 104. The conical shape of the tapered housing 102 is arranged so that pair of hingedly articulating wing arms 110, 112 are forced to change spacing and position relative to each other based on their position in the tapered housing 102. This change in positioning for the wing arms 110, 112 results in axial displacement of at least one shaft gear into meshed engagement and disengagement with a plurality of drive gears.

In some embodiments, a central shaft 33 extends concentrically across the length of the tapered housing 102. Central shaft 33 carries at least one shaft gear that selectively engages and disengages a plurality of drive gears to change the gear ratios. In one embodiment, the central shaft 33 does not slide, but rather rotates independently of a wing collar 126 and the at least one gear shaft.

In some embodiments, central shaft 33 may be defined by a wing end and a gear end. A wing collar 126 slides along the wing end of the central shaft. At least one shaft gear operatively connects to the wing collar 126. The at least one shaft gear slides along the gear end of the central shaft in correlation to the wing collar 126. Thus, the wing collar 126 axially displaces the at least one shaft gear into selective mesh engagement with a plurality of drive gears.

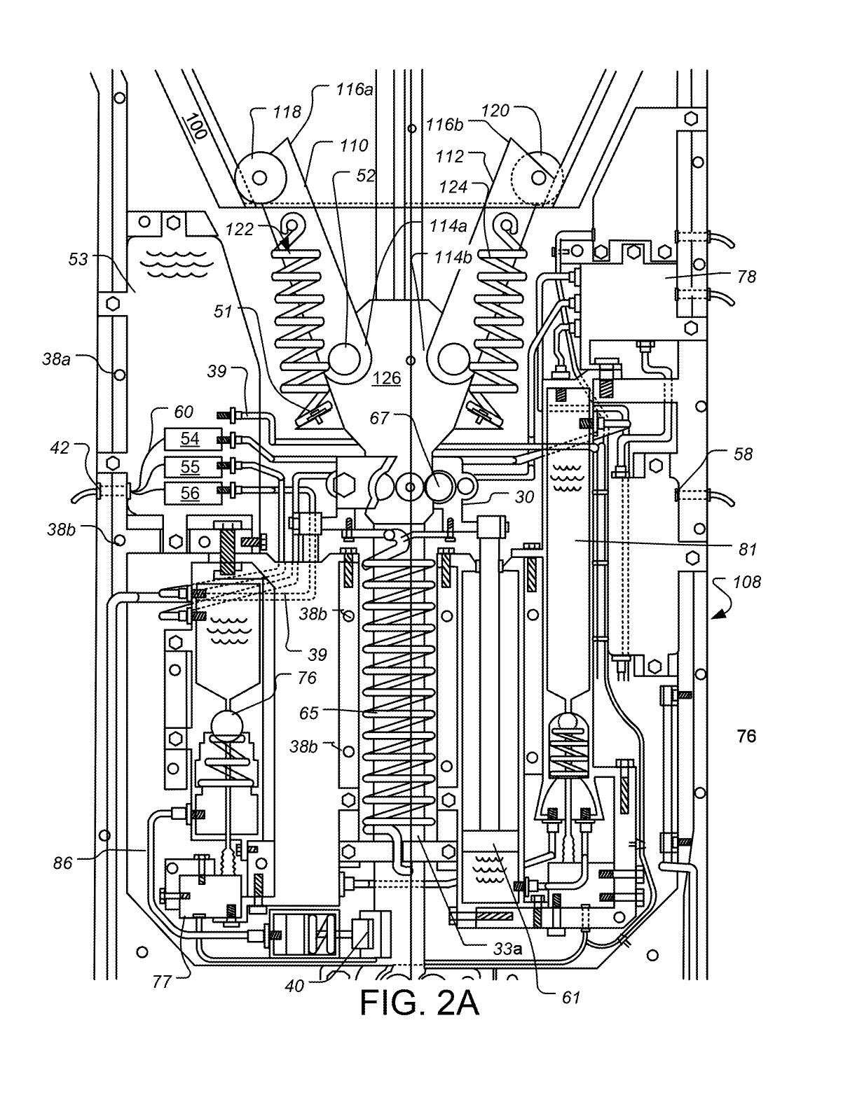

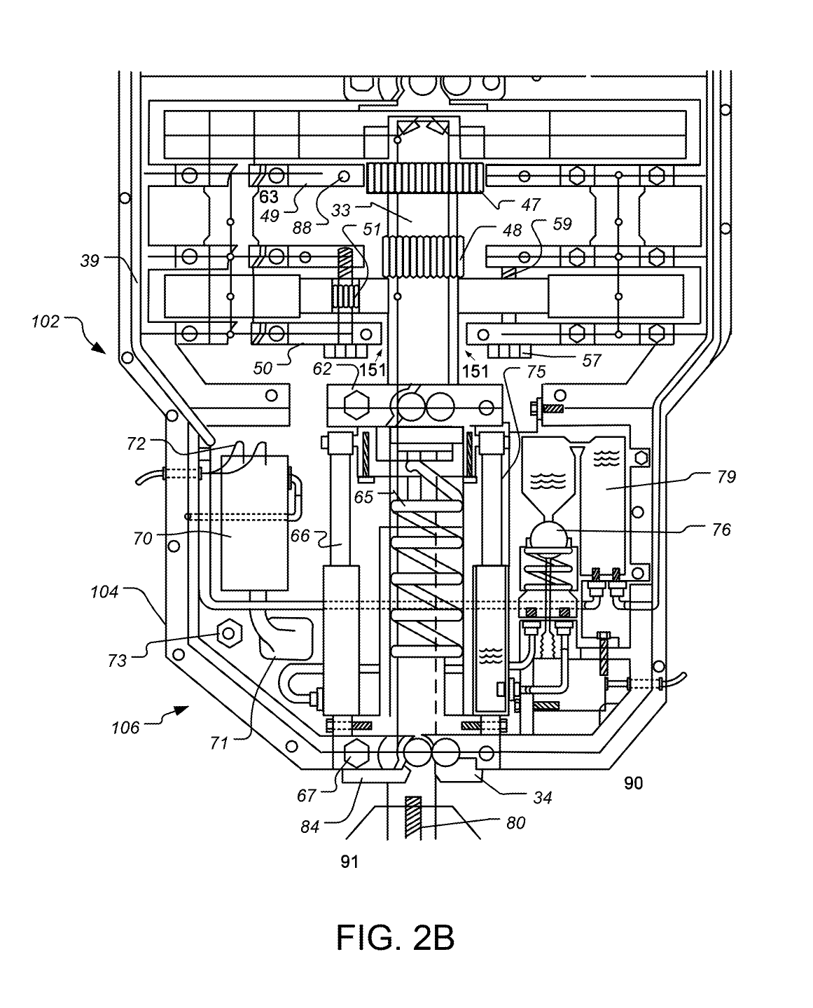

Looking now at FIGS. 2A and 2B, a pair of wing arms 110, 112 defined by an inner end 114a, 114b and an outer end 116a, 116b drives the wing collar 126 along the central shaft. Inner end 114a, 114b of the wing arms 110, 112 hingedly join with the wing collar 126, and the outer end 116a, 116b of the wing arms 110, 112 move along the rails 44a, 44b on the sidewall 104 of the housing. A wing arm wheel 118, 120 joins the outer end 116a, 116b of wing arms 110, 112 to roll along the rails 44a, 44b that extend along the housing. Because wing arm wheels 118, 120 and rails 44a, 44b are in constant contact, there is no gear change but instead a seamless, undetectable increase, decrease in the ratio and central shaft.

FIGS. 3A, 3B, and 3C illustrate the cone shaped transmission apparatus 100 shown in FIG. 2A, where FIG. 3A shows the pair of winged arms extended coaxially at the wide end 108 of the tapered housing 102, FIG. 3B shows the pair of winged arms moving towards the narrow end 106 of the tapered housing 102, and FIG. 3C shows the pair of winged arms folded at the narrow end 106 of the tapered housing 102. The position of wing arms 110, 112 conform to changing diameters of the tapered housing 102.

The illustrations show that FIG. 3A is the starting position of wing arms 110, 112, resulting in a gear ratio that is about 1:1. As shown in FIG. 3B, wing arms 110, 112 are at an intermediary stage inside the tapered housing 102, resulting in a higher ratio to affect the output shaft. FIG. 3C illustrates the wing arms 110, 112 at the narrow end 106 of the tapered housing 102. This is smallest diameter and, thus the highest ratio, which results in a high gear, or overdrive.

For example, when wing arms 110, 112 are displaced towards the wide end 108 of the tapered housing 102, the wing collar 126s are generally extended and the wing collar 126 is carried to the wide end 108. However, when the wing arms 110, 112 are displaced towards the narrow end 106 of the tapered housing 102, the wing arms 110, 112 hingedly fold inwardly and the wing collar 126 is carried to the narrow end 106 of the tapered housing 102. The wing collar 126 axially displaces a plurality of shaft gears at the gear end of the central shaft into selective mesh engagement with a plurality of drive gears, so as to achieve gear ratios between, approximately 1:1 to 3:1. Thus, the shaft gears are axially displaced in communication with correlating drive gears based on the position of the wing arms 110, 112.

As referenced in FIG. 2B, one possible embodiment of apparatus 100 comprises a tapered housing 102. The tapered housing 102 follows a generally conical shape that sloped from 10° to at least 45°. The tapered housing 102 may be defined by a sidewall 104, a wide end 108, and a narrow end 106, whereby the wide end 108 forms a wide opening and the narrow end 106 forms a narrow opening. In some embodiments, a pair of rails 44a, 44b running along the length of the sidewall 104 between the wide end 108 and the narrow end 106. Rails 44a, 44b enable wing arms 110, 112 to easily slide along the sidewall 104 of the tapered housing 102, as described below.

In some embodiments, apparatus 100 may also include a central shaft 33 that extends concentrically through the length of the tapered housing 102. Central shaft 33 does not axially slide, but rather rotates independently of a wing collar 126 and shaft gear, as described below. The central shaft is defined by a wing end and a gear end. The wing end is proximal to the engine, while the gear end is proximal to the plurality of drive gears. Apparatus 100 may also include a shaft brake 40 to stop rotation of the shaft. Central shaft 33 may be fabricated from a solid metal, such as an aluminum alloy, steel, and tungsten.

In some embodiments, apparatus 100 may also include a wing collar 126 that operatively connects to the central shaft, the wing collar 126 sliding along the wing end of the central shaft. Wing collar 126 may be ring-shaped and enable passage of the central shaft towards the wing end. In one embodiment, the central shaft comprises two shafts, where one shaft is recessed inside the gear shaft. The shafts do not slide (extend and retract). Instead, the shaft gear and wing collar 126 slides on their respective shafts.

In some embodiments, apparatus 100 may also include at least one shaft gear joined with central shaft 33. The at least one shaft gear operatively connects to the wing collar 126. In one embodiment, the at least one shaft gear comprises a disc having teeth that are sized and dimensioned to mesh with the plurality of drive shafts. The wing collar 126 slides along the central shaft to displace the shaft gear along the gear end of the central shaft. In this manner, the shaft gear selectively engages and disengages the plurality of drive gears. This selective engagement between gears is meshed and enables the gear ratio to change.

Those skilled in the art will recognize that a gear ratio is the ratio of the speed of rotation of the powered gear of a gear train to that of the final or driven gear. The gear ratio is defined as the input speed relative to the output speed. The gear ratio is defined as the input speed relative to the output speed. It is typically written as: Gear Ratio=w:w. Thus, if a small drive gear is replaced with a folding wing gear, the diameter of the wing arms 110, 112 can fluctuate when placed inside the tapered housing 102. Thus permitting various ratios on the shaft between 1:1 and 3:1.

The shaft gear represents input power while the shaft rail represents output power and an altered ratio of speed. The wing arms 110, 112 inside the tapered housing 102 change the distance between the contact point of the wing arm and the rails 44a, 44b. Those skilled in the art will recognize that distance is equal to circumference, and since the tapered housing 102 diameter is fixed at its wide end 108, all rotational speed below that contact point, with the central shaft effect a ratio change of the central shaft; whereby the wing arm contact point, when touching the smallest circumference of the sidewall 104 of the tapered housing 102, is equivalent to a multiple gear change.

In some embodiments, the apparatus 100 increases and decreases gear ratios based on the distance between the wing arm wheels 118, 120 as the wing collar 126 travels up or down the central shaft. The wing arms 110, 112 under continuous spring tension expand and contract inside the tapered housing 102 while sliding along the central shaft. The shaft rail has raised key at 6 o'clock and 12 o'clock corresponding to a female notch inside the sidewall 104 of the tapered housing 102. This allows the wing collar 126 and attached wing arms 110, 112 to slide up and down the central shaft while maintaining a synchronized rotation with the central shaft.

In some embodiments, the central shaft comprises a shaft rail. The central shaft may also include at least one square key notch operable to engage the shaft rail. The at least one square key notch is disposed at the wing end and the gear end of the central shaft. The at least one square key notch helps inhibit the wing collar 126 from rotating around the shaft rail while sliding along the length of the central shaft. In yet another embodiment, the central shaft is defined by an oil channel disposed concentrically along the length of the central shaft.

The square key notch protrudes approximately ¼″ high and is ¼″ wide. The shaft is the output shaft and singular support of the wing collar 126. The purpose of the notches is to prevent the wing collar 126 from rotating around the shaft rail while at the same time permitting the wing collar 126 to travel from the top to the bottom of its length. The shaft rail is closest to the engine, when configured as an automatic transmission. The shaft rail is secured in a recess on the inside of the tapered housing 102.

In some embodiments, the apparatus 100 may also include a pair of wing arms 110, 112 defined by an inner end 114a, 114b and an outer end 116a, 116b. The inner end 114a, 114b of the pair of wing arms 110, 112 hingedly join with the wing collar 126. In one embodiment, there is a wing arm on each side of the wing collar 126. The outer end 116a, 116b of the pair of wing arms 110, 112 operatively join with the pair of rails 44a, 44b to move along the pair of rails 44a, 44b.

The wing arms 110, 112 expand and retract while moving along the length of the tapered housing 102 in relation to the slope of the sidewall 104. In one embodiment, the wing arms 110, 112 are hinged so they may conform to various diameters of the cone gear. For example, when the wing arm 110, 112 has loaded to house the diameter at the tapered housing 102, a 2:1 gear ratio occurs at the central shaft. A frame chassis 45 provides stability for the wing arms 110, 112 while rolling along the rails 44a, 44b.

A wing arm wheel joins with the outer end 116a, 116b of the pair of wing arms 110, 112. The wing arm wheel rolls along the rails 44a, 44b that extend along the sidewall 104 of the tapered housing 102. The wing arms 110, 112 displace the wing collar 126 along the central shaft. In this manner, the disposition of the pair of wing arms 110, 112 conforms to the diameter of the tapered housing 102.

As the wing arms 110, 112 move towards the narrow end 106 of the tapered housing 102, gear reduction occurs in the distance between the wing arm contact points. Because the wing arm wheel and rails 44a, 44b on the sidewall 104 are in constant contact, there is no gear change but instead a seamless, undetectable increase, decrease in the ratio and output shaft. In some embodiments, the apparatus 100 may also include a pair of tension springs 122, 124 generating tension for pressing the outer end 116a, 116b of the pair of wing arms 110, 112 against the pair of rails 44a, and 44b. A retainer bolt 51 helps fasten the pair of tension springs 122, 124 to the tapered housing 102. A rubber grommet 58 can be used as a spacer for the bolt 51.

In some embodiments, an engine provides the power for operation of the rear drive wheels by transferring power to the transmission apparatus 100. The engine is connected to a flywheel 36. In some embodiments, the flywheel 36 may include a rotating mechanical device that is used to store rotational energy. The flywheel 36 provides a moment of inertia and thus resists changes in rotational speed. The amount of energy stored in the flywheel 36 is proportional to the square of its rotational speed. A plurality of impeller fins 35 operatively connected to the flywheel 36.

Energy from the motor is transferred to the flywheel 36 by the application of a torque to it, thereby increasing its rotational speed, and hence its stored energy. In one embodiment, the flywheel 36 connects to a torque converter 31. The torque converter is operable to transfer the power to the pair of wing arms 110, 112. A nut 42 that works with a bolt and at least one bolt hole 38a, 38b, 38c for fastening the flywheel 36 and a transmission cover, and also to secure the flywheel 36 to the engine torque converter 31.

The torque converter 31 is a fluid dampener or fluid clutch, between the input power of the engine and the object of its transmission in this case a cylindrical, cone shaped apparatus 100. Inside the torque converter are two circular configurations of impellers, (FIGS. 3A, 3B), while impellers are fixed to impellers, are free-floating but externally connecting to the cone via a splined shaft. As a result, impellers turn at the same rotation of the engines crank because the converter is bolted to it, while impellers remain unmoving. However, when engine rpm's are increased, impeller bins splash fluid (transmission fluid) into the opposite fins which activates their rotation, thus coupling the engines rotation speed to the cone. The cone rides on ball bearings in the chassis of the transmission 150.

As the cone spins inside the transmission it transmits its rotational speed directly to the wing arms number that spin with the cone on tracks inside the wall of the cone wing arms pivot off a collar mated to a steel shaft. The shaft is grooved so the collar can slide on the shaft but prevents the shaft from spinning inside the collar shaft number one 33a is held in position in a sealed bearing recess number in the large diameter of the cone its opposite end is connected to a male and female coupling number to a second shaft number 33b. The Two shafts are interconnected through roller bearings because shaft number one 33a rotates clockwise and shaft number two 33b will rotate counter-clockwise when in a reverse position.

A hydraulic telescopic ram 61 controls the position of the collar. The cone, shaft collar and wing arms rotate as a unit. The ram is fixed using a bearing housing 30 so the unit can spin and travel in a back-and-forth direction throughout the travel movement of the collar. The shaft diameter never changes, however as the collar travels forward toward the large diameter of the cone, the wing arms expand and create a larger circumference acting on a fixed one, thus changing the ratio of the shaft.

The cone shaft collar and wing arms are the components that comprise the variable ratios. The gears in the drawing have nothing to do with the ratios. In the drawing, the transmission is in the drive position therefore gear 48 is between an opening and the frame. The opening in the frame is splined to mesh with the gear 48 and prevent shaft 33a from rotating. The outside diameter of the shaft is also. To activate reverse, a telescopic hydraulic ram 66, electronically programmed to move a specific distance and fixed to a bracket 91, moves gears 47 and 48 simultaneously. When gear 48 meshes with gear 59. Gear 59 acts as an idler gear of shaft 33b only reversing that shaft. Neutral occurs when gears 47 and 48 free float and mesh with no other gear. Drive occurs when gear 47 locks inside shaft 33a which, simultaneously disconnects gear 48. When gear 48 locks into area 151 between the frame opening, gear 47 is also disconnected achieving park.

The CG4 for is a fully automatic transmission meant for general purpose in rear wheel driven cars and trucks. In the present configuration approximately 15 to 20 different speed ratios are possible based on the angle of the cylindrical walls of the cone-shaped apparatus. Seamless shifting occurs through the fluid thrust of electronically actuated hydraulic movement. Vehicle sensors supply data to computers that in turn adjust the ratios according to torque, speed, engine load, etcetera. As a result the CG4 is always in the optimal power curve and increasing fuel economy.

Every internal part of the CG4 is accessible by removing a cover plate bolted to the frame. It is therefore possible to service and rebuild the transmission without removing it from the vehicle because only a small number of parts are needed in this design and they are configured mostly side-by-side, resulting in a lighter and thinner package occupying less space.

In some embodiments the apparatus 100 further comprises a hydraulic oil pump 70 for forcing a hydraulic fluid from a hydraulic fluid reservoir 53 through a hydraulic line 39 to the wing arms 110, 112. Oil resistant wiring 72 may be used to transmit power to oil pump 70. A hydraulic junction box 78 helps regulate flow of hydraulic fluid. A seal 34 helps inhibit leakage of the hydraulic fluid. A hydraulic ram 75 and a plunger 90 are operable to displace the hydraulic fluid. At least one hydraulic ram controller 79, 81 and a hydraulic ram return spring 65 are used in operation of the hydraulic ram 75. An actuator 77 and a check ball 76 facilitate motion of the hydraulic ram. One particular ram 66 is used to position the sleeve gear to Park, Reverse, Neutral, and Overdrive.

In some embodiments apparatus 100 may also include electrical components that help to actuate the hydraulic rams 61. The electrical components may include an electronic control module, a wiring harness 86, a wiring 60, and a plurality of solenoids 54, 55, 56. These electrical components enable operational connectivity to a constant power source and a vehicle main computer from the engine. The apparatus 100 further comprises an oil pump, an oil pick up tube 71, an oil drain plug 73, and oil restricted wiring.

In some embodiments, apparatus 100 may also include a bearing 67 and race assembly for lubricating moving components. Additionally, a flat sleeve bearing 88, a bearing cap 84, a needle bearing 63, and a bearing collar 62 may be used for creating stability and reducing friction between components of the apparatus 100. The bearing are housed in a bearing housing 30, and serve to create stability for the central shaft 33, and provides a strong anchor point while central shaft and shaft gear revolve at different speeds. In one embodiment, a heavy duty bearing, while stationary in the recess, allows the shaft rail to rotate independently at a different speed in the tapered housing 102. The difference in rotational speed between the shaft rail and the shaft gear is measured as gear ratio.

Wing collar 126 is notched on its inside diameter to accept the notched shaft rail. Wing collar 126 provides a solid pivotal point arms positioned on either side. The wing collar 126 rotates at shaft real speed and is mechanically the transition between input and output rotation variables occurring as the wing collar 126 travels inside the tapered housing 102. The wing collar 126 intermediates variable speeds travels in a linear trajectory, and is analogous to the central point in which all hearing ratios are calculated.

Housing is separated from the wing collar 126 by high-speed roller bearings, thus permitting the shaft rail and wing collar 126 independent rotation. The central shaft does not rotate but is machined to accommodate a bearing race on its inside diameter. The other house the bearing race on outside wing collar 126. A flange is provided for mounting hydraulic rams on each side of wing arms 110, 112. The hydraulic rams are constantly receiving sensory data by vehicle computer and adjusting the mechanism up or down the shaft rail accordingly. A drive yoke 80 carries the transferred power to the vehicle shaft drives for operation of the vehicle. Thus gear ratios are electronically adjusted to terrain, engine load, speed, etc.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A cone shaped variable gear cylinder apparatus, the apparatus comprising:
a tapered cylinder defined by a sidewall, a wide end, and a narrow end, whereby the wide end is closed and the narrow end forms a narrow opening;
a pair of rails running along the length of the sidewall between the wide end and the narrow end;
a central shaft extending concentrically through the length of the tapered cylinder, the central shaft defined by a wing end and a gear end;
a wing collar operatively joined with the central shaft, the wing collar sliding along the wing end of the central shaft;
at least one shaft gear joined with the central shaft, the at least one shaft gear operatively connected to the wing collar, whereby the wing collar displaces the at least one shaft gear along the gear end of the central shaft, whereby the at least one shaft gear selectively engages and disengages a plurality of drive gears;
a pair of wing arms defined by an inner end and an outer end, the inner end of the pair of wing arms hingedly joined with the wing collar, the outer end of the pair of wing arms operatively joined with the pair of rails to move along the pair of rails, the pair of wing arms displacing the wing collar along the central shaft, whereby the disposition of the pair of wing arms conforms to the diameter of the tapered housing; and
a pair of tension springs generating tension for pressing the outer end of the pair of wing arms against the pair of rails.

2. The apparatus of claim 1, further comprising an engine operable to generate power, the engine connected to a flywheel, the flywheel connected to a torque converter, the torque converter operable to transfer the power to the pair of wing arms.

3. The apparatus of claim 2, further comprising a bolt and a bolt hole operable to help fasten the flywheel to the engine and fasten a transmission cover to the tapered housing.

4. The apparatus of claim 3, further comprising a plurality of impeller fins operatively connected to the flywheel.

5. The apparatus of claim 1, further comprising a retainer bolt operable to fasten the pair of tension springs to the tapered housing.

6. The apparatus of claim 1, further comprising a hydraulic oil pump operable to store and pump a hydraulic fluid.

7. The apparatus of claim 6, further comprising a seal operable to inhibit leakage of the hydraulic fluid.

8. The apparatus of claim 7, further comprising a hydraulic ram and a plunger operable to displace the hydraulic fluid.

9. The apparatus of claim 8, further comprising a hydraulic ram controller and a hydraulic ram return spring, and a check ball.

10. The apparatus of claim 1, further comprising a wing arm wheel joined with the outer end of the pair of wing arms.

11. The apparatus of claim 1, wherein the central shaft comprises a shaft rail and a shaft brake.

12. The apparatus of claim 11, wherein the central shaft comprises at least one square key notch operable to engage the shaft rail.

13. The apparatus of claim 12, wherein the at least one square key notch is disposed at the wing end and the gear end of the central shaft.

14. The apparatus of claim 13, wherein the central shaft is defined by an oil channel disposed concentrically along the length of the central shaft.

15. The apparatus of claim 1, further comprising an electronic control module, a wiring harness, a wiring, an actuator, and a plurality of solenoids.

16. The apparatus of claim 1, further comprising a bearing, a bearing housing, a race assembly, a flat sleeve bearing, a bearing cap, a needle bearing, and a bearing collar.

17. The apparatus of claim 1, further comprising an oil pump, an oil pick up tube, an oil drain plug, and oil restricted wiring.

18. The apparatus of claim 1, further comprising a flat sleeve bearing, a bearing cap, a needle bearing, and a bearing collar.

19. The apparatus of claim 1, wherein the apparatus is operatively connected to a constant power source.

20. A cone shaped variable gear cylinder apparatus, the apparatus consisting of:
a tapered cylinder defined by a sidewall, a wide end, and a narrow end, whereby the wide end is closed and the narrow end forms a narrow opening;
a pair of rails running along the length of the sidewall between the wide end and the narrow end;
a central shaft extending concentrically through the length of the tapered housing, the central shaft defined by a wing end and a gear end, the central shaft further defined by a shaft rail, the central shaft further defined by an oil channel disposed concentrically along the length of the central shaft, the central shaft further defined by at least one square key notch operable to engage the shaft rail;
a wing collar operatively joined with the central shaft, the wing collar sliding along the wing end of the central shaft;
at least one shaft gear joined with the central shaft, the at least one shaft gear operatively connected to the wing collar, whereby the wing collar displaces the at least one shaft gear along the gear end of the central shaft, whereby the at least one shaft gear selectively engages and disengages a plurality of drive gears;
a pair of wing arms defined by an inner end and an outer end, the inner end of the pair of wing arms hingedly joined with the wing collar, the outer end of the pair of wing arms operatively joined with the pair of rails to move along the pair of rails, the pair of wing arms displacing the wing collar along the central shaft, whereby the disposition of the pair of wing arms conforms to the diameter of the tapered housing;
a pair of tension springs generating tension for pressing the outer end of the pair of wing arms against the pair of rails;
an engine operable to generate power;
a flywheel operatively connected to the engine, the flywheel connected to a torque converter, the torque converter operable to transfer the power to the pair of wing arms;
a plurality of impeller fins operatively connected to the flywheel;
a constant power source;
a vehicle main computer;
a hydraulic oil pump operable to store and pump a hydraulic fluid;
a seal operable to inhibit leakage of the hydraulic fluid;
a hydraulic ram and a plunger operable to displace the hydraulic fluid;
an electronic control module;
a wiring harness having a wiring;
an actuator;
a plurality of solenoids; and
a bearing and a race assembly.
